(19) United States
(12) Patent Application Publication
(10) Pub. No.: US 2014/0313158 A1
(43) Pub. Date: Oct. 23, 2014

(54) DETECTING METHOD AND DETECTING DEVICE FOR CAPACITIVE TOUCH-CONTROL APPARATUS, AND THE CAPACITIVE TOUCH-CONTROL APPARATUS

(71) Applicant: FocalTech Systems, Ltd., Grand Cayman, KY (US)

(72) Inventors: Lianghua MO, Guangdong (CN); Weiping LIU, Guangdong (CN)

(73) Assignee: FocalTech Systems, Ltd., Grand Cayman, KY (US)

(21) Appl. No.: 14/083,175

(22) Filed: Nov. 18, 2013

(30) Foreign Application Priority Data
Apr. 17, 2013 (CN) 201310134055.7

(51) Int. Cl. G06F 3/041; G06F 3/044

(52) U.S. Cl. CPC G06F 3/0418; G06F 3/044
USPC 345/174

(57) ABSTRACT

A detecting method for a capacitive touch-control apparatus is disclosed, which includes: sequentially driving M groups of electrodes in a first dimension and N groups of electrodes in a second dimension for detection, wherein either of M and N is a natural number, any group of electrodes includes two or more electrodes and the two or more electrodes are detected simultaneously; and calculating a first dimension coordinate and a second dimension coordinate of a touch position according to a result of the detection on the groups of electrodes in the first dimension and in the second dimension, respectively, to determine a group of possible touch positions. A corresponding device is further provided.

### CROSS REFERENCE TO RELATED APPLICATION

This application claims the benefit of priority to Chinese Patent Application No. 201310134055.7, entitled “DETECTING METHOD AND DETECTING DEVICE FOR CAPACITIVE TOUCH-CONTROL APPARATUS, AND THE CAPACITIVE TOUCH-CONTROL APPARATUS”, filed on Apr. 17, 2013 with State Intellectual Property Office of PRC, which is incorporated herein by reference in its entirety.

### BACKGROUND

1. Field of the Disclosure

The present disclosure relates to touch-control apparatus, and in particular, to a detecting method and a detecting device for a capacitive touch-control apparatus, and the capacitive touch-control apparatus.

2. Background of the Technology

The detection solutions for capacitive touch-control apparatus include self-capacitive detection solution and mutual-capacitive detection solution. In the self-capacitive detection solution, the capacitance to ground of an electrode in the touch-control apparatus is detected, i.e., a detecting circuit transmits a scan signal via the electrode and receives from the same electrode a feedback signal, by which the capacitance to ground of the electrode is calculated. Since a human body has a great capacitance to ground and thus can be taken as approximately equivalent to the ground, the capacitance to ground of the current electrode will be increased when a touch event occurs on the current electrode. As shown in FIG. 1, Cp denotes the initial capacitance to ground of the current electrode, Cf denotes the capacitance between the current electrode and the human body, and then the current capacitance to ground of the current electrode is the parallel capacitance value of Cp and Cf. Therefore, if an increase in the capacitance to ground of the current electrode is detected by the detecting circuit, it can be determined that a touch occurs on the current electrode, and the position where the touch occurs may be further determined according to variation of the capacitance to ground of individual electrodes. According to the mutual-capacitive detection solution, a scan signal is transmitted from an electrode and received from another electrode, and then the magnitude or the variation of the capacitance between the two electrodes is calculated.

FIG. 2 shows a common touch screen structure which includes electrodes T1, T2 . . . T16 in the X-axis direction and includes electrodes R1, R2 . . . R10 in the Y-axis direction. When a change in capacitance to ground of T13, T14 and T15 as well as R3, R4 and R5 is detected, the X-axis coordinates of a touch position may be obtained through the variance in the capacitance of T13, T14 and T15, and the Y-axis coordinates of the touch position may be obtained through the variance in the capacitance of R3, R4 and R5.

According to the solution commonly-used in the prior art, a detecting circuit is switched to detect the capacitance to ground of each of the electrodes in the touch-control apparatus in a time-sharing way, and the electrodes currently not scanned are grounded or floated. When a charger with poor quality is connected to the system where the touch-control apparatus resides, noise (i.e., the so-called power interference) will arise in the system ground with respect to the true ground. The human body will be treated as a noise source when the detecting circuit takes the system ground as a reference, and the noise is coupled to the detecting circuit by a capacitor between the human body and an electrode. At this time, the capacitance detected by the detecting circuit is not accurate.

Since the detection on the electrodes is performed in a time-sharing way according to the prior art, the power interferences on different electrodes during the detection are uncorrelated to each other, the power interferences may not be eliminated when the touch position is calculated, resulting in an inaccurately determined touch position which is different from the actual touch position.

### SUMMARY

A detecting method for a capacitive touch-control apparatus, a detecting device for a capacitive touch-control apparatus and a capacitive touch-control apparatus are provided according to an embodiment of the invention so as to solve the technical problem of a detecting result being not accurate in the existing touch-control apparatus due to the power interference.

A detecting method for a capacitive touch-control apparatus is provided according to a first aspect of the invention, which includes: sequentially driving M groups of electrodes in a first dimension and N groups of electrodes in a second dimension for detection, wherein either of M and N is a natural number, and any group of electrodes includes two or more electrodes and the two or more electrodes are detected simultaneously; and calculating a first dimension coordinate and a second dimension coordinate of a touch position according to the result of the detection on the groups of electrodes in the first dimension and in the second dimension, respectively, to determine a group of possible touch positions.

A detecting device for a capacitive touch-control apparatus is provided according to a second aspect of the invention, which includes: a first detecting module, configured to sequentially drive M groups of electrodes in a first dimension and N groups of electrodes in a second dimension for detection, wherein either of M and N is a natural number, any group of electrodes includes two or more electrodes and the two or more electrodes are detected simultaneously; and a calculating module, configured to calculate a first dimension coordinate and a second dimension coordinate of a touch position according to the result of the detection on the groups of electrodes in the first dimension and in the second dimension, respectively, to determine a group of possible touch positions.

A capacitive touch-control apparatus is provided according to a third aspect of the invention, which includes the device as described above.

In embodiments of the invention, electrodes of a touch-control apparatus are divided into multiple groups and the plurality of electrodes of each group are detected simultaneously. Therefore, when there exists power interference, power interference components in the detection results of the plurality of electrodes in one group are correlated to each other, i.e., having a determined association relationship. Then the power interference may be eliminated with a certain algorithm in the subsequent calculation, and an accurate touch position may be determined.

### BRIEF DESCRIPTION OF THE DRAWINGS

FIG. 1 is a schematic diagram for detecting a capacitance to ground when a touch event occurs;

FIG. 2 is a schematic diagram of a common touch screen structure;

FIG. 3 is a schematic diagram of a detecting method for a capacitive touch-control apparatus according to an embodiment of the invention;

FIG. 4 is a schematic diagram of a capacitive touch screen structure;

FIG. 5 is a schematic diagram of multiple-point touch;

FIG. 6 is a principle diagram of the mutual-capacitive scanning technology; and

FIG. 7 is a schematic diagram of a detecting device for a capacitive touch-control apparatus according to an embodiment of the invention.

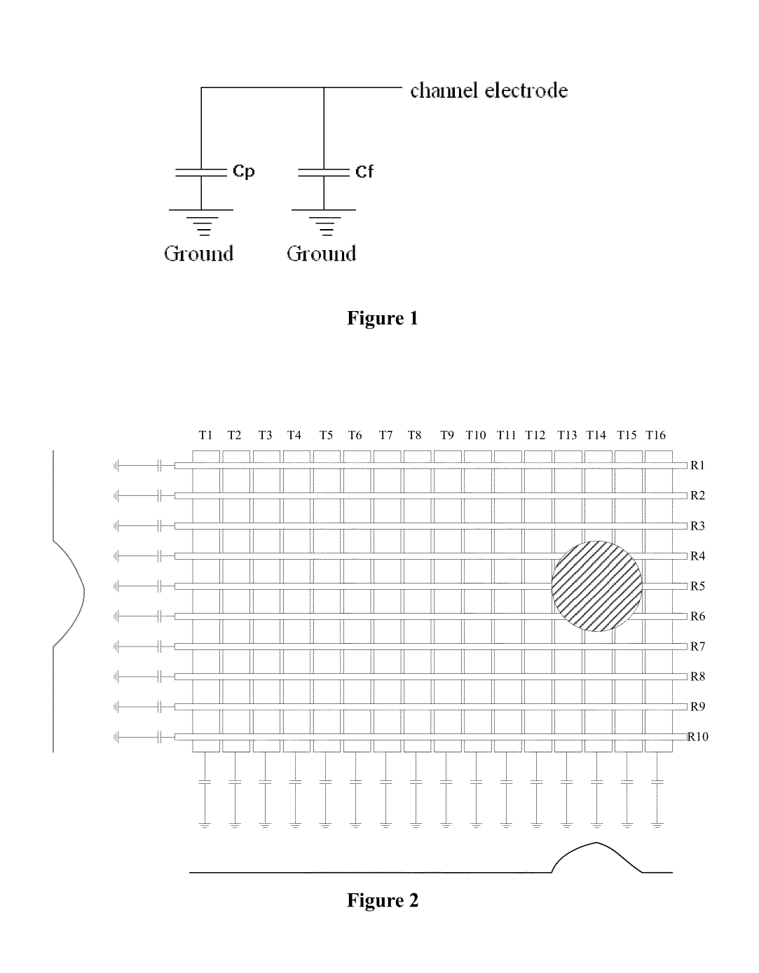

### DETAILED DESCRIPTION

A detecting method for a capacitive touch-control apparatus, a detecting device for a capacitive touch-control apparatus, and the capacitive touch-control apparatus are provided according to embodiments of the invention, which may eliminate influence of power interference and determine an accurate touch position. A corresponding device is further provided according to an embodiment of the invention. The embodiments of the invention will be described below in detail in conjunction with the drawings.

### First Embodiment

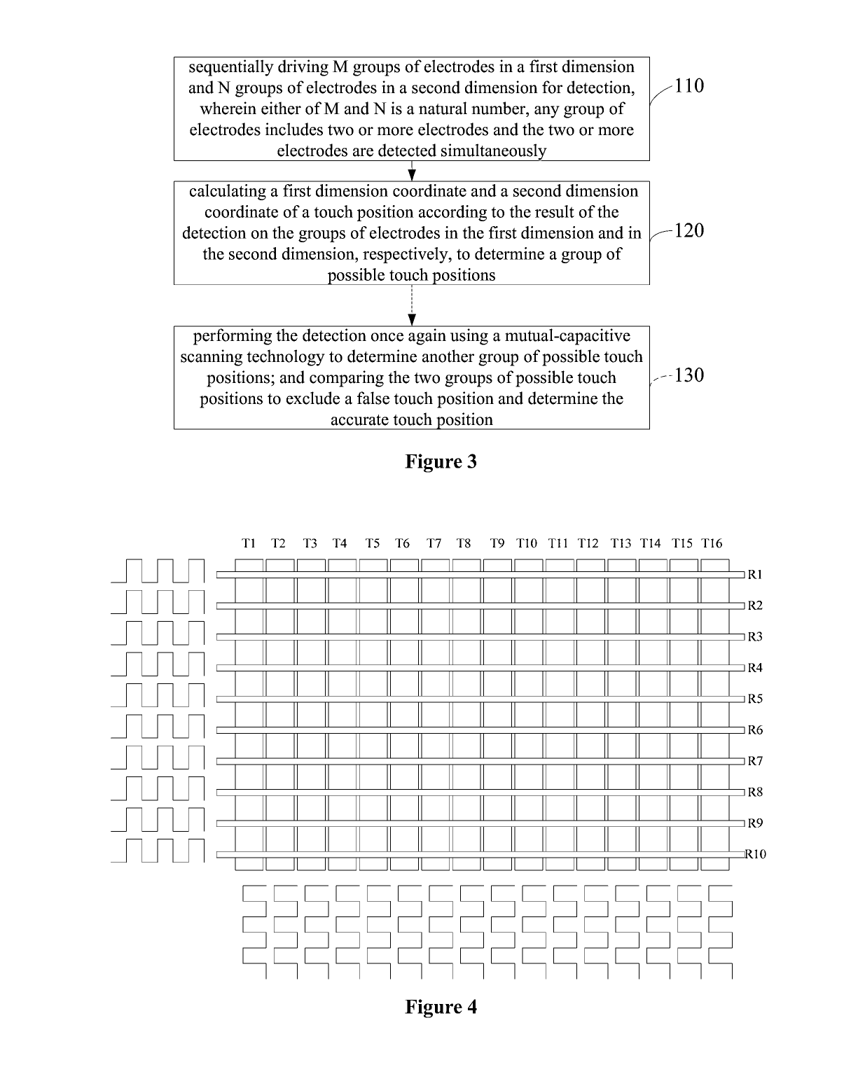

Referring to FIG. 3, a detecting method for a capacitive touch-control apparatus is provided according to the embodiment of the invention, which includes the steps 110-120.

110, sequentially driving M groups of electrodes in a first dimension and N groups of electrodes in a second dimension for detection, wherein either of M and N is a natural number, any group of electrodes includes two or more electrodes and the two or more electrodes are detected simultaneously.

In the present embodiment, electrodes in individual dimensions of a touch-control apparatus are divided into several groups to be detected by groups. By taking the capacitive screen structure shown in FIG. 4 as an example, the capacitive screen includes electrodes arranged in two dimensions, in which 16 electrodes are arranged in the first dimension (i.e., in the X-axis direction) and respectively denoted by T1, T2 . . . T16, and 10 electrodes are arranged in the second dimension (i.e., in the Y-axis direction) and respectively denoted by R1, R2 . . . R10.

As one example, the 16 electrodes in the X-axis direction may be divided into the following groups: a first group including T1 to T6, a second group including T5 to T10, a third group including T9 to T14, and a fourth group including T13 to T16. The 10 electrodes in the Y-axis direction may be divided into the following groups: a fifth group including R1 to R6, and a sixth group including R6 to R10. In the grouping described above, one or more electrodes are shared by two adjacent groups in each dimension. Certainly, other grouping may be applied in other embodiments, which will not be described herein.

In the present embodiment, the detection is performed on the groups as determined above. The detection is performed by driving two or more electrodes included in one group of electrodes during one period and driving two or more electrodes included in a next group of electrodes to during a next period. The process continues until the detection is completed. The self-capacitive detection solution is adopted for this detection, which includes: driving a group of electrodes to transmit a scan signal, and receiving a feedback signal by the group of electrodes.

120, calculating a first dimension coordinate and a second dimension coordinate of a touch position according to the result of the detection on the groups of electrodes in the first dimension and in the second dimension, respectively, to determine a group of possible touch positions.

If a touch occurs at the intersection of the electrode T4 with the electrode R8, it may be found, after sequentially detecting several groups of electrodes in the X-axis direction, that the change in the capacitance to ground of the electrode T4 is the greatest and the capacitances to ground of the electrodes T3 and T5 on both sides of the electrode T4 are also changed. Then the X-axis coordinate of the touch position, for example at T4, may be calculated according to changes in capacitances of T3, T4 and T5. Similarly, the Y-axis coordinate of the touch position, for example at R8, may be calculated according to changes in the capacitances of R7, R8 and R9. Therefore, the position at (T4, R8) where the touch event occurs may be determined.

According to the aforementioned detection solution, since the electrodes T3, T4 and T5 belong to a same group of electrodes and are detected simultaneously, the power interference components, if exist, in the detection data for T3, T4 and T5 are correlated to each other. Therefore, in the calculation of the X-axis coordinate, the influence of the power interference components may be eliminated with a conventional algorithm, so as to calculate an accurate X-axis coordinate. Similarly, since the electrodes R7, R8 and R9 also belong to one group of electrodes, the influence of the power interference components may also be eliminated with a conventional algorithm, so as to calculate an accurate Y-axis coordinate.

The principle to eliminate power interference will be further described as follows.

In the case that there is no power interference, if a touch occurs, the calculation of coordinates is based on the variations obtained from the detection on the electrodes, where the variations are proportional to capacitances between the electrodes with the human body. The variations on respective electrodes are assumed to be A1, A2, A3 . . . An. In the case that there exists power interference, the system ground is taken as a reference by the detecting circuit, the human body is equivalent to a noise source, and noise is coupled to the electrodes by the capacitors between each of the electrodes and the human body. In the solution of detecting a group of electrodes simultaneously according to the present embodiment, since the noise source is the same and the noise is also proportional to the capacitance between human body and the electrodes, it may be concluded that the noise is proportional to the variance in the capacitance caused by touch. It is assumed that the proportional coefficient is k, the variances caused by noise are kA1, kA2, kA3 . . . kAn, wherein k changes over time. It can be seen that though power noise interference components applied to the electrodes are not equal to each other, the ratios of the interferences simultaneously applied on the electrodes to the variances caused by touch from human body are equal to each other. Therefore, the influences of power interference on the electrodes may be counteracted with a certain algorithm.

In conclusion, with the aforementioned detection solution where electrodes are grouped to be detected it may be ensured that the electrode at the touch position and at least one electrode in the vicinity are detected simultaneously. The power interference noises on these electrodes are correlated, and thus the influence of the power interference may be overcome through a certain algorithm so as to determine the accurate touch position. Preferably, in order to ensure that the electrode at the touch position and two electrodes respectively on both sides of the electrode are detected simultaneously to further improve anti-interference capability, one or more of the most marginal electrodes in each group are preferably grouped into another adjacent group, such that the marginal electrodes of each group may be scanned repeatedly. Certainly, in order to save electrodes or reduce the number of scans, the marginal electrodes of each group may not be scanned repeatedly such that the detecting circuit may be omitted, however, the anti-interference capability of the region where these marginal electrodes locate may be decreased.

In one example, driving a group of electrodes for detection includes: driving each electrode in the group of electrodes to transmit a scan signal and receiving a feedback signal from each electrode in the group of electrodes; and meanwhile, driving each electrode other than the group of electrodes to transmit a same scan signal and refraining from receiving a feedback signal from any electrode other than the group of electrodes. As shown in FIG. 4, while driving the fifth group of electrodes R1 to R6 to transmit a scan signal, all other electrodes may be driven to transmit a same scan signal; and a feedback signal is received only from the fifth group of electrodes R1 to R6 but not from any other electrodes. In this way, in one aspect the detection performed on the fifth group of electrodes R1 to R6 may not be interfered, and in the other aspect scanning waveforms for all the electrodes in the touch-control apparatus may be consistent with each other. Therefore, when there is a foreign matter such as a water drop on the surface of the touch-control apparatus, the interference of the foreign matter such as the water drop may be avoided. The principle of avoiding interference of the water drop is that: in the case that the scanning waveforms for the electrodes are consistent, voltages of a current scanning electrode and an electrode where the water drop locates change simultaneously, therefore the measurement for the capacitance to ground may not be influenced. The detection solution according to the present embodiment may be referred to as a full screen common mode scanning solution.

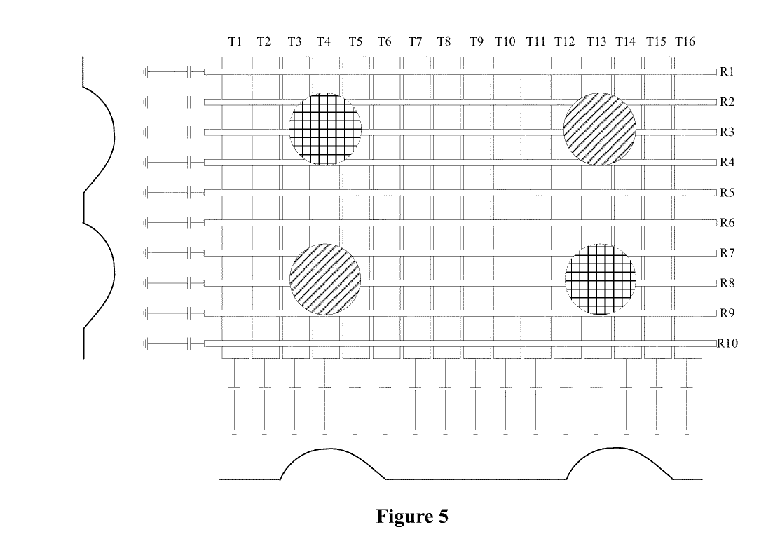

If the touch-control apparatus supports multi-touch, the group of touch positions determined at step 120 may include two or more positions. As shown in FIG. 5, assuming that the touch occurs at two positions (T4, R8) and (T13, R3), it is detected with the aforementioned detection solution that the changes in capacitances to ground of T4, T13 as well as R3, R8 are the greatest, then the determined possible touch positions may be the two points (T4, R8) and (T13, R3), or may be the two points (T4, R3) and (T13, R8), or may further be the four points (T4, R8), (T13, R3), (T4, R3) and (T13, R8). The situation in which the detected touch position is not consistent with the actual touch position, i.e., the presence of a false touch position, is referred to as a problem of “ghost point”.

In one embodiment, to solve the “ghost point” problem, in the case where a group of possible touch positions determined at step 120 includes two or more positions, the method may further include the following step 130.

130, performing the detection once again using a mutual-capacitive scanning technology to determine another group of possible touch positions; and comparing the two groups of possible touch positions to exclude a false touch position and determine the accurate touch position.

In the mutual-capacitive scanning technology, it is to drive one electrode to transmit a scan signal and to receive the scan signal from another electrode, and a magnitude or a variance of the capacitance between the two electrodes may be calculated from the received signal. The multi-touch may be achieved with the mutual-capacitive scanning technology. In the present embodiment, performing detection once again using a mutual-capacitive scanning technology includes: sequentially driving each of the electrodes in the first dimension to transmit a scan signal, and sequentially receiving the scan signal from each of N groups of electrodes in a second dimension in the period during which the scan signal is transmitted from any one of the electrodes in the first dimension, wherein two or more electrodes included in any group of electrodes in the second dimension simultaneously receive the scan signal. Certainly, all the electrodes in the second dimension may not need to be grouped, but function to receive the scan signal simultaneously as one group when the scan signal is transmitted by any one of the electrodes in the first dimension.

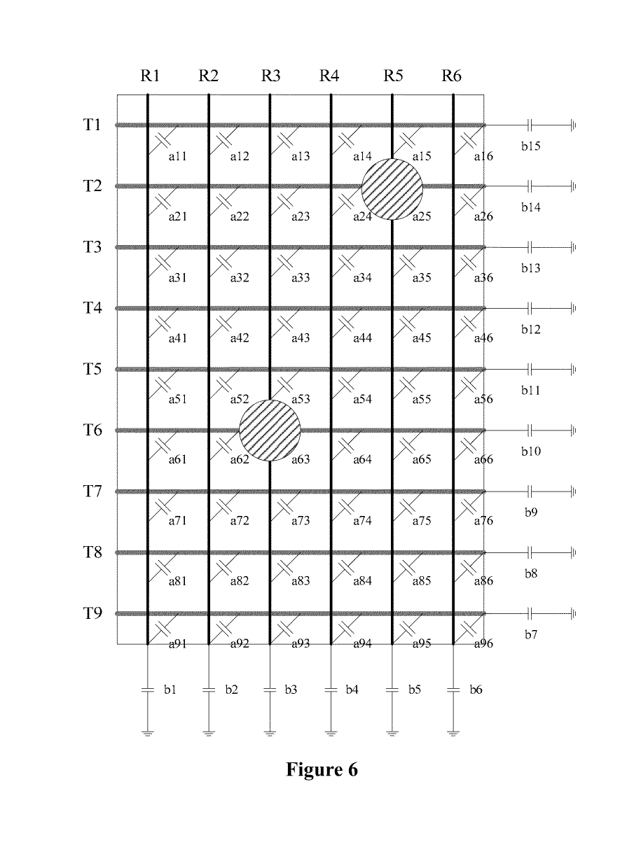

The mutual-capacitive scanning will be further introduced by referring to FIG. 6. As shown in FIG. 6, electrodes T1 to T9 in the Y-axis direction sequentially transmit a scan signal under the condition that only one Y-axis electrode transmits the scan signal at a time. X-axis electrodes are divided into several groups as discussed above, and only a first group of electrodes R1 to R6 are shown. In the period during which a scan signal is transmitted from a Y-axis electrode, the groups of X-axis electrodes sequentially receive the scan signal. Two or more electrodes included in a same group simultaneously receive the scan signal. For example, when the electrode T1 transmits the scan signal, the electrodes R1 to R6 of the first group simultaneously receives the scan signal, and six capacitances C1.1, C1.2, . . . C1.6 between the electrode T1 and the electrodes R1-R6 are obtained by detection. In this way, q*p capacitances may be obtained after the detection, where q and p respectively indicate the number of electrodes in the X-axis direction and in the Y-axis direction.

Assuming that the touch occurs at two positions (T4, T8) and (T13, R3), it is detected that the capacitance of C4.8 and C13.3 changes greatly, and thus (T4, R8) and (T13, R3) may be determined to be touch positions. Finally, by comparing the two groups of possible touch positions determined by the two technologies at the step 120 and the step 130 respectively, the false touch positions such as (T4, R3) and (T13, R8) may be excluded, and the accurate touch positions such as (T4, R8) and (T13, R3) may be determined.

Therefore, according to the present embodiment, the problem of “ghost point” may be solved through repeating detection using the mutual-capacitive scanning technology, such that an accurate touch position may be determined.

In conclusion, a detecting method for a capacitive touch-control apparatus is provided according to the embodiment of the invention. In the method, electrodes in multiple dimensions of a touch-control apparatus are divided into multiple groups and the plurality of electrodes of one group are detected simultaneously. Therefore, in the case that there exists power interference, the power interference components in the detection results for the plurality of electrodes in one group are correlated to each other, and thus the power interference may be eliminated with a certain algorithm to determine an accurate touch position. Further, while detecting a group of electrodes, all other electrodes other than the group of electrodes are driven to simultaneously transmit a same scan signal but are not detected, by which the problem of water drop interference may be overcome. Furthermore, when a determined group of possible touch positions include two or more positions, the problem of “ghost point” may be solved by repeating the detection using the mutual-capacitive scanning technology.

### Second Embodiment

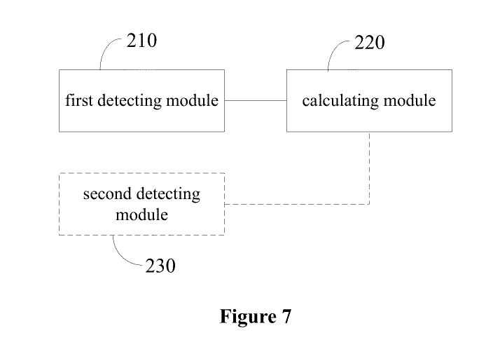

Referring to FIG. 7, a detecting device for a capacitive touch-control apparatus is provided according to the embodiment of the invention, which includes:

a first detecting module 210, configured to sequentially drive M groups of electrodes in a first dimension and N groups of electrodes in a second dimension for detection, wherein either of M and N is a natural number, any group of electrodes includes two or more electrodes and the two or more electrodes are detected simultaneously; and

a calculating module 220, configured to calculate a first dimension coordinate and a second dimension coordinate of a touch position according to the result of the detection on the groups of electrodes in the first dimension and in the second dimension, respectively, to determine a group of possible touch positions.

Specifically, the first detecting module 210 may be configured to drive each electrode in a group of electrodes to transmit a scan signal and configured to receive a feedback signal from each electrode in the group of electrodes which transmit the scan signal; and meanwhile, configured to drive each electrode other than the group of electrodes to transmit the same scan signal. The first detecting module 210 may include: a scanning unit configured to drive each electrode in a group of electrodes to transmit a scan signal; and a receiving unit configured to receive a feedback signal from each electrode in the group of electrodes which transmit the scan signal.

In one example, the device may further include: a second detecting module 230 configured to perform the detection once again by using a mutual-capacitive scanning technology; and the calculating module 220 may be further configured to determine, according to the detection results from the second detecting module, another group of possible touch positions, and configured to compare two groups of possible touch positions obtained by the first detecting module and the second detecting module to exclude a false touch position and to determine an accurate touch position.

Specifically, the second detecting module 230 may be configured to sequentially drive each of the electrodes in the first dimension to transmit a scan signal, and configured to sequentially receive the scan signal from each of N groups of electrodes in the second dimension in the period during which any one of the electrodes in the first dimension transmits the scan signal, wherein two or more electrodes in any group of electrodes in the second dimension simultaneously receive the scan signal. The second detecting module 230 may include: a scanning unit configured to drive one electrode to transmit a scan signal; and a receiving unit configured to receive a feedback signal from a group of electrodes.

Brief description for a detecting device for a capacitive touch-control apparatus provided according to the present embodiment is made above, and for more details reference may be made to the disclosure of the first embodiment.

On the basis of the detecting device for a capacitive touch-control apparatus, a touch-control apparatus including the device is provided according to an embodiment of the invention.

In conclusion, a capacitive touch-control apparatus and a detecting device for the same are provided according to embodiments of the invention. In the detecting device, electrodes in multiple dimensions of the touch-control apparatus are divided into multiple groups, and a plurality of electrodes in each group are detected simultaneously. Therefore, when there exists power interference, the power interference components in the detection results for the plurality of electrodes in one group are correlated to each other, and thus the power interference may be eliminated with a certain algorithm in the subsequent calculation to determine an accurate touch position. Further, while detecting a group of electrodes, the device may drive all other electrodes to simultaneously transmit a same scan signal without performing detection on the other electrodes, such that the problem of water drop interference may be overcome. Furthermore, when a determined group of possible touch positions include two or more positions, the device may perform the detection once again using a mutual-capacitive scanning technology such that the problem of “ghost point” may be solved.

It can be understood by those skilled in the art that all or some of the steps in the various methods of the aforementioned embodiments may be implemented with a hardware, or may be implemented with a related hardware by following instructions of a program which may be stored in a computer readable medium, which may include ROMs, RAMs, magnetic disks, optical disks and the like.

The detecting method and detecting device for a capacitive touch-control apparatus, and the capacitive touch-control apparatus according to embodiments of the invention have been described in detail above. However, the descriptions for the embodiments above are intended to facilitate understanding the method and ideas disclosed herein, and should not be interpreted as limiting the scope of the disclosure. Variations or substitutions easily conceived by those skilled in the art within the technical scope disclosed herein should fall into the protection scope of the invention.

What is claimed is:

1. A detecting method for a capacitive touch-control apparatus, comprising:
sequentially driving M groups of electrodes in a first dimension and N groups of electrodes in a second dimension for detection, wherein either of M and N is a natural number, any group of electrodes comprises two or more electrodes and the two or more electrodes are detected simultaneously; and
calculating a first dimension coordinate and a second dimension coordinate of a touch position according to a result of the detection on the groups of electrodes in the first dimension and in the second dimension, respectively, to determine a group of possible touch positions.

2. The method according to claim 1, wherein sequentially driving M groups of electrodes in the first dimension and N groups of electrodes in the second dimension for detection comprises:
driving each electrode in a group of electrodes to transmit a scan signal and receiving a feedback signal from each electrode in the group of electrodes; and meanwhile, driving each electrode other than the group of electrodes to transmit the same scan signal.

3. The method according to claim 1, further comprising, in the case that two or more positions are contained in the determined group of possible touch positions:
performing the detection once again using a mutual-capacitive scanning technology to determine another group of possible touch positions; and
comparing the two groups of possible touch positions to exclude a false touch position and to determine an accurate touch position.

4. The method according to claim 3, wherein performing the detection once again using a mutual-capacitive scanning technology comprises:
sequentially driving each of the electrodes in the first dimension to transmit a scan signal, and sequentially receiving the scan signal from each of the N groups of electrodes in the second dimension in a period during which the scan signal is transmitted from any one of the electrodes in the first dimension, wherein the two or more electrodes comprised in any group of electrodes in the second dimension simultaneously receive the scan signal.

5. The method according to claim 2, further comprising, in the case that two or more positions are contained in the determined group of possible touch positions:
performing the detection once again using a mutual-capacitive scanning technology to determine another group of possible touch positions; and
comparing the two groups of possible touch positions to exclude a false touch position and to determine an accurate touch position.

6. The method according to claim 5, wherein performing the detection once again using a mutual-capacitive scanning technology comprises:
sequentially driving each of the electrodes in the first dimension to transmit a scan signal, and sequentially receiving the scan signal from each of the N groups of electrodes in the second dimension in a period during which the scan signal is transmitted from any one of the electrodes in the first dimension, wherein the two or more electrodes comprised in any group of electrodes in the second dimension simultaneously receive the scan signal.

7. A detecting device for a capacitive touch-control apparatus, comprising:
a first detecting module, configured to sequentially drive M groups of electrodes in a first dimension and N groups of electrodes in a second dimension for detection, wherein either of M and N is a natural number, any group of electrodes comprises two or more electrodes and the two or more electrodes are detected simultaneously; and
a calculating module, configured to calculate a first dimension coordinate and a second dimension coordinate of a touch position according to a result of the detection on the groups of electrodes in the first dimension and in the second dimension, respectively, to determine a group of possible touch positions.

8. The device according to claim 7, wherein the first detecting module is configured to: drive each electrode in a group of electrodes to transmit a scan signal and receive a feedback signal from each electrode in the group of electrodes which transmit the scan signal; and meanwhile, drive each electrode other than the group of electrodes to transmit the same scan signal.

9. The device according to claim 7, further comprising a second detecting module, configured to perform the detection once again using a mutual-capacitive scanning technology;
wherein the calculating module is further configured to: determine another group of possible touch positions according to the result of the detection from the second detecting module; and compare the two groups of possible touch positions to exclude a false touch position and to determine an accurate touch position.

10. The device according to claim 9, wherein the second detecting module is configured to: sequentially drive each of the electrodes in the first dimension to sequentially transmit a scan signal, and sequentially receive the scan signal from each of the N groups of electrodes in the second dimension in a period during which the scan signal is transmitted from any one of the electrodes in the first dimension, wherein the two or more electrodes comprised in any group of electrodes in the second dimension simultaneously receive the scan signal.

11. The device according to claim 8, further comprising a second detecting module, configured to perform the detection once again using a mutual-capacitive scanning technology;
wherein the calculating module is further configured to: determine another group of possible touch positions according to the result of the detection from the second detecting module; and compare the two groups of possible touch positions to exclude a false touch position and to determine an accurate touch position.

12. The device according to claim 11, wherein the second detecting module is configured to: sequentially drive each of the electrodes in the first dimension to sequentially transmit a scan signal, and sequentially receive the scan signal from each of the N groups of electrodes in the second dimension in a period during which the scan signal is transmitted from any one of the electrodes in the first dimension, wherein the two or more electrodes comprised in any group of electrodes in the second dimension simultaneously receive the scan signal.

13. A capacitive touch-control apparatus comprising a detecting device, wherein the detecting device comprises:
a first detecting module, configured to sequentially drive M groups of electrodes in a first dimension and N groups of electrodes in a second dimension for detection, wherein either of M and N is a natural number, any group of electrodes comprises two or more electrodes and the two or more electrodes are detected simultaneously; and
a calculating module, configured to calculate a first dimension coordinate and a second dimension coordinate of a touch position according to the result of the detection on the groups of electrodes in the first dimension and in the second dimension, respectively, to determine a group of possible touch positions.
